(19) United States
(12) Patent Application Publication
(10) Pub. No.: US 2016/0378285 A1
(43) Pub. Date: Dec. 29, 2016

(54) Automatic Detection of Semantics

(71) Applicant: SAP SE, Walldorf (DE)

(72) Inventors: Michael Graf, Stuttgart (DE); Holger Knospe, Wiesloch (DE); Oliver Klemenz, Hoffenheim (DE); Vladislav Bezrukov, Walldorf (DE)

(73) Assignee: SAP SE

(21) Appl. No.: 14/748,816

(22) Filed: Jun. 24, 2015

(51) Int. Cl. G06F 3/0484; G06F 17/27; G06F 17/30; G06F 3/0482

(52) U.S. Cl. CPC G06F 3/0484; G06F 3/0482; G06F 17/2785; G06F 17/30604; G06F 17/30598

(57) ABSTRACT

A system, a method, and a computer program product for automatic detection of semantics are disclosed. A user interface containing a first element and a second element in a plurality of elements is generated. At least one semantic relationship is defined between the first element and the second element. An action on the first element is performed based on an action performed on the second element using the semantic relationship.

### TECHNICAL FIELD

This disclosure relates generally to data processing and, in particular, to an automatic detection of semantics.

### BACKGROUND

In today's world, many companies rely on software applications to conduct their business. Software applications deal with various aspects of companies' businesses, which can include finances, product development, human resources, customer service, management, and many other aspects. Software applications typically operate from servers and can be stored in memory. To use software applications, users typically employ various computing devices. User interfaces provide users with an ability to provide instructions to software applications, interact with other users, and perform various functionalities in furthering their company's business.

User interfaces can include a variety of software tools that can be generated by the corresponding software applications. The tools can assist users with performing their tasks, such as word processing, graphics creation, application development, etc. User interfaces can also be useful in providing collaboration among users. The users are able to place various items on the user interface, such as links, text, documents, etc. However, the users are not provided with an ability to define various relationships among items that are placed on the user interfaces as well as execute actions on groups of elements that may be related to one another. Lack of such abilities can have a significant impact on productivity, efficiency, cost, etc. Thus, there is a need to provide an ability to define various relationships among user interface elements and allow use of such relationships to perform a variety of actions.

### SUMMARY

In some implementations, the current subject matter relates to a computer-implemented method for automatic detection of semantics. The method can include generating a user interface containing a first element and a second element in a plurality of elements, defining at least one semantic relationship between the first element and the second element, and performing, using the semantic relationship, an action on the first element based on an action performed on the second element. At least one of the generating, the defining, and the performing can be performed by at least one processor of at least one computing system.

In some implementations, the current subject matter can include one or more of the following optional elements. The semantic relationship can include at least one of the following: a group relationship, a line relationship, an association relationship, a headline relationship, a categorization relationship, and a sprite relationship. The plurality of elements can include at least one of the following: a text, an image, a video, an audio, a note, a document, and a link, and/or any other elements and/or any combination thereof.

In some implementations, the method can also include triggering performance of an action on another element in the plurality of elements based on the action performed on at least one of the first element and the second element.

In some implementations, the semantic relationship can be determined based on a distance between the first element and the second element on the generated user interface. The semantic relationship can also be determined based on respective locations of the first and second element in at least one section of the generated user interface.

In some implementations, the method can also include storing at least one identifier indicative of the semantic relationship and associating the stored identifier with the first element and the second element.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates an exemplary system for providing a collaboration user interface, according to some implementations of the current subject matter;

FIG. 2 illustrates an exemplary user interface displaying organization of elements on the user interface based on various relationships among elements, according to some implementations of the current subject matter;

FIG. 3 illustrates an exemplary user interface displaying a plurality of elements of varying importance, according to some implementations of the current subject matter;

FIG. 4 illustrates an exemplary user interface displaying a plurality of elements in an ordered fashion, according to some implementations of the current subject matter;

FIG. 5 illustrates an exemplary user interface for grouping various elements, according to some implementations of the current subject matter;

FIG. 6 illustrates an exemplary user interface containing sectioning structuring elements, according to some implementations of the current subject matter;

FIG. 7 illustrates an exemplary an exemplary user interface containing further sectioning structuring elements, such as axes and/or quadrants, according to some implementations of the current subject matter;

FIG. 8 illustrates an exemplary user interface that can indicate a parent-child relationship between one or more elements, according to some implementations of the current subject matter;

FIG. 9 illustrates an exemplary user interface that can indicate association relationship among elements, according to some implementations of the current subject matter;

FIG. 10 illustrates an exemplary user interface that can indicate categorization semantic relationship among elements, according to some implementations of the current subject matter;

FIG. 11 illustrates an exemplary user interface for combining implicit and/or explicit semantic relationships, such as for the purposes of determining information from the content, according to some implementations of the current subject matter;

FIG. 12 illustrates an exemplary user interface that can provide grouping and/or clustering of elements, according to some implementations of the current subject matter;

FIG. 13 illustrates an exemplary user interface that can define trigger areas and/or actions;

FIGS. 14a-b illustrate exemplary ways of arranging storage of information associated with particular elements being manipulated on a user interface, according to some implementations of the current subject matter;

FIG. 15 is a diagram illustrating an exemplary system including a data storage application, according to some implementations of the current subject matter;

FIG. 16 is a diagram illustrating details of the system of FIG. 15;

FIG. 17 illustrates an exemplary system, according to some implementations of the current subject matter; and

FIG. 18 illustrates an exemplary method, according to some implementations of the current subject matter.

### DETAILED DESCRIPTION

In some implementations, the current subject matter relates to an ability to provide a user interface that is capable of providing a pin board like collaboration area where objects can be detected based on various object attributes, e.g., object data, semantics, metadata, etc. In some implementations, the current subject matter can provide users with user interface containing a two-dimensional area that can be used to for managing content, manipulate content, collaboratively work together in a visual way, as well as perform various functions. The content can be any content and can be freely positioned, arranged, manipulated, etc. The content can be structured using associations, groups, lines, and/or any other tools. The content can also be a free-form content and does not require a predefined structure and/or semantics. The content can include at least one of the following: texts, links, documents, persons, ideas, etc. and/or any combination thereof. In some implementations, the content can be arranged, clustered, and/or related to other content. This can be helpful when generating insight and can be used to derive automatic actions and/or analysis of the content.

In some implementations, content semantics can be defined in a visual, non-technical way, e.g., two items that are positioned next to each other can be two similar ideas and/or other objects that can relate to one another in any way. The current subject matter can identify content semantics between the objects manually and/or automatically based on arrangement and/or structuring elements related to the content, e.g., lines, groups, headlines and/or any other elements, displayed on the user interface.

In some implementations, to manage content on the user interface, the current subject matter can ascertain the objects and/or mechanisms that can be used in connection with the user interface. Several types of elements can be used for managing content on the user interface, which can include at least one of the following: structuring items (e.g., groups, lines, associations (arrows, connections, etc.), headlines, sprites, etc.) content and/or business items (e.g., text, images, videos, links to other content, persons (e.g., identification information related to individuals, etc.), ideas, notes (e.g., SAP Notes as developed by SAP SE, Walldorf, Germany), documents, tasks, etc.) and/or any other elements and/or any combination thereof.

In some implementations, the above elements can be added to the user interface without indicating any structure and/or specific position (i.e., they can be positioned freely). Upon placement of an element on the user interface, the element's position, size, depth, and/or any other semantic attributes can be ascertained. Additional semantic attributes can include at least one of the following: relationships among elements, importance of elements, order of elements, grouping of elements, sectioning of elements, hierarchy of elements (e.g., parent, child, grand-child, etc.), association of elements, categorization of elements, etc. and/or any combination thereof.

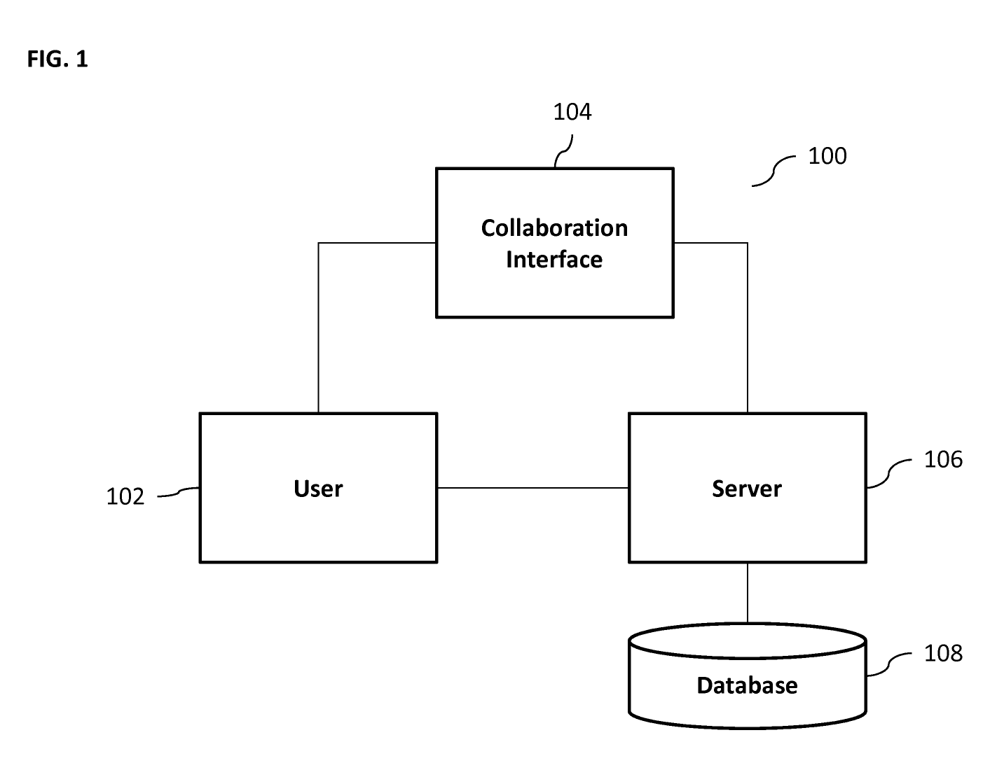

FIG. 1 illustrates an exemplary system 100 for providing a collaboration user interface, according to some implementations of the current subject matter. The system 100 can include a collaboration user interface 104, a server 106, and a database 108. A user 102 can access the user interface 104 using any computing device that can be communicatively coupled to the server 106. The server 106 can be coupled to a database 108, which can store data, various elements, and which can be used for storing of information that the user 102 can generate using the user interface 104.

In some implementations, the user interface 104 can allow the user to generate various elements and/or objects for placement on the user interface and create various associations, relations, etc. among the elements. The user 102 can also access the database 108 using the server 106 to obtain various elements for placement on the user interface 104. In some implementations, a plurality of users 102 can access the user interface 104 to supply various elements, content, objects, etc.

As stated above, the user interface 104 can allow organization of the elements on the user interface in accordance with various methodologies. Positioning, depth, size, etc. can be used by a processor in the server 106 to determine how elements can appear on the user interface 104.

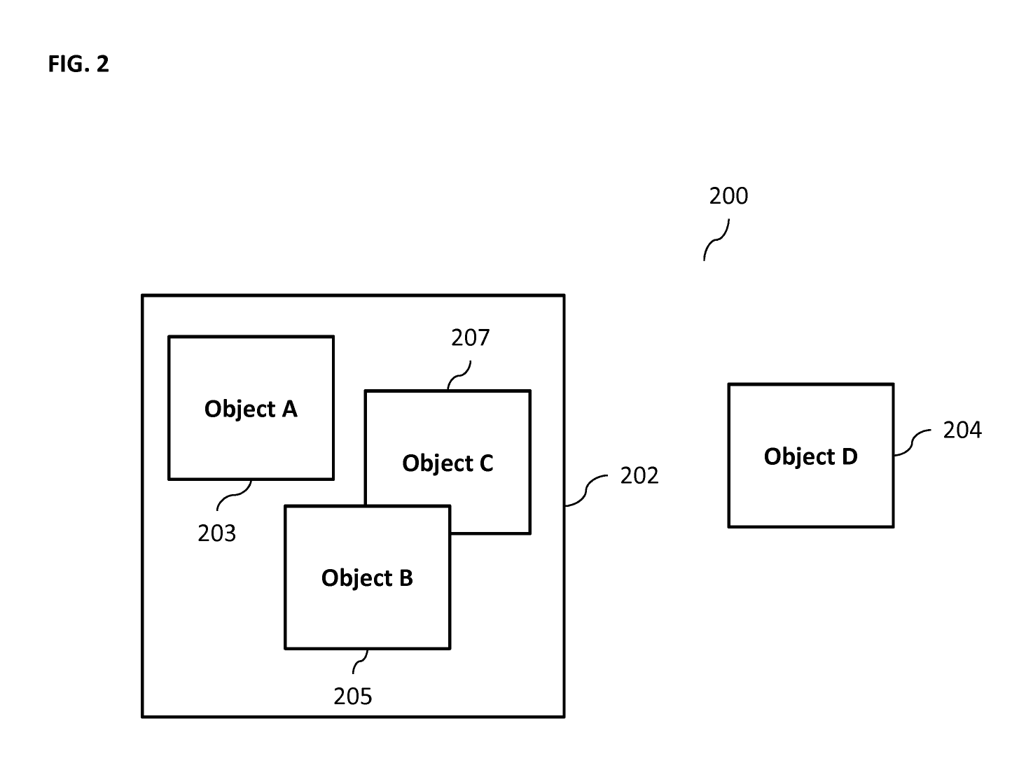

In some implementations, elements can be positioned on the user interface using various relationships that may exist between the elements. FIG. 2 illustrates an exemplary user interface 200 (similar to user interface 104 shown in FIG. 1) displaying organization of elements on the user interface based on various relationships among elements. User interface 200 can include object A element 203, object B element 205, object C element 207 and object D element 204. In some implementations, elements 203, 205, and 207 can be determined to be related to one another (e.g., using their position, size, depth, common content, similar semantics, etc.) and hence can be clustered together using box 202. As shown in FIG. 2, element 204 is not related to the elements 203, 205, 207 and hence is positioned outside of the cluster box 202. In some implementations, x and y coordinates of the elements and/or distance between elements can be used to determine their location on the user interface.

For example, elements 203 can correspond to a text, element 205 can correspond to an idea (e.g., as developed by the user 102 shown in FIG. 2), and element 207 can correspond to a link. Elements 205 and 207 can graphically intersect one another, indicating a collision among these two elements. In some implementations, a two-dimensional collision detection algorithm on the x and y coordinates of the elements 202, 203, 204, 205, and 207 can be to identify semantic relationships between the items (i.e., collision of items 205 and 207; neighboring relations between elements 203, 205, and 207; and no relationship between box 202 (and elements 203, 205, 207) and element 204). In some implementations, the following exemplary, non-limiting pseudo code can be used by the server 106 (shown in FIG. 1) to define relationships between the elements shown in the user interface 200.

```
deriveRelation = function (items) {
  for (i = 0; i < items.length; i++) {
    allOtherItems = items.remove(items[i]);
    collisions = calculateCollision(items[i], allOtherItems, 0); // 0px threshold
    neighbors = calculateCollisions(items[i], allOtherItems, 50); // 50px threshold
    for (j = 0; j < collisions.length; j++) {
      items[i]. addStrongRelationWith(colisions[j], calculateDistance(items[i], collisions[j]));
    }
    for (j = 0; j < neighbors.length; j++) {
      items[i]. addWeakRelationWith(neighbors [j], calculateDistance(items[i], neighbors [j]));
    }
  }
  addStrongRelationWith = function (item, distance) {
    this.strongRelations.add(item, distance);
  }
  addWeakRelationWith = function (item, distance) {
    this.weakRelations.add(item, distance);
  }
  calculateCollisions = function (item, items, threshold) {
    results = [ ];
    itemBoundingBox = calculateBoundingBox(item.x − threshold, item.y − threshold, item.width +
  2* threshold, item.height + 2* threshold);
    for(i = 0; i < items.length; i++) {
    itemToCheckBoundingBox = calculateBoundingBox(items[i].x − threshold, items[i].y −
  threshold, items[i].width + 2* threshold, items[i].height + 2* threshold);
    if (intersects(itemBoundingBox, itemToCheckBoundingBox)) {
      results.add(items[i]);
    }
    return results;
  }
```

In some implementations, the current subject matter can use importance of elements to position the elements on the user interface. For example, some elements can be more important than other elements (e.g., an element corresponding to a purchase order for products to be fulfilled on expedited basis, etc.). In some implementations, more important elements can be resized on the user interface to appear larger than other elements, thereby indicating an amplified importance.

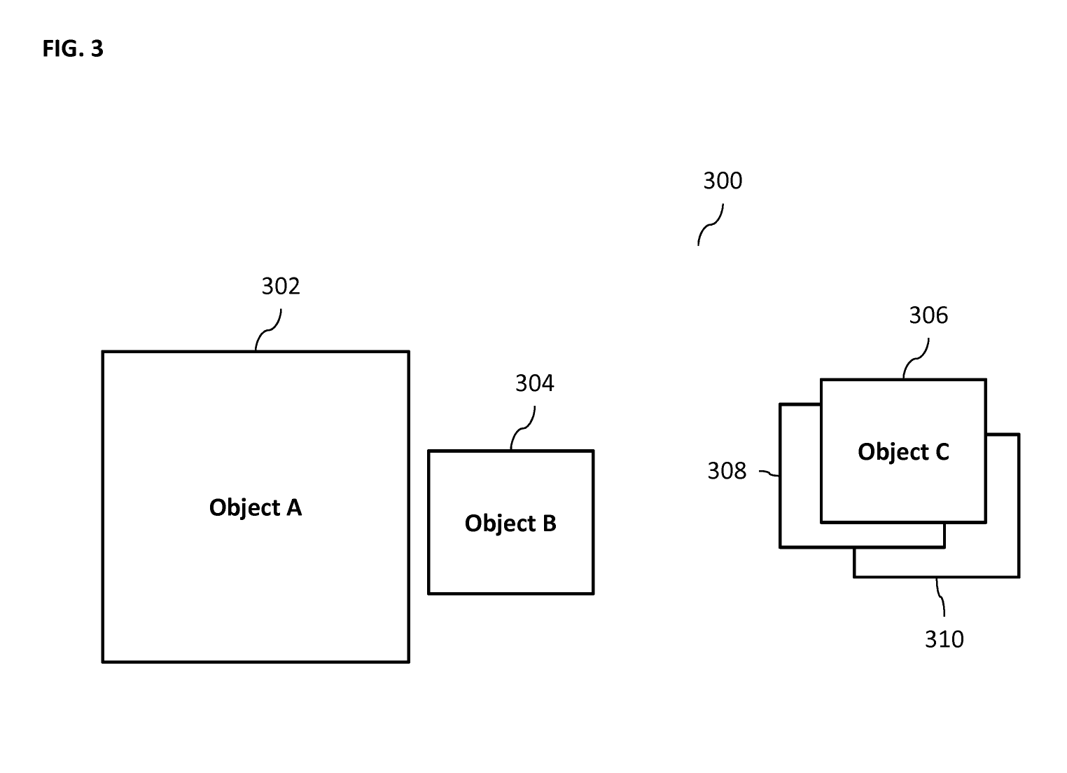

FIG. 3 illustrates an exemplary user interface 300 (similar to user interface 104 shown in FIG. 1) displaying a plurality of elements of varying importance. As shown in FIG. 3 an object A element 302 can be made to appear larger than object B element 304. Hence, a larger size of an element can be indicative of its importance. Alternatively, smaller size can be indicative of element's importance. Additionally, a depth of an element can be used to designate importance of an element. For example, as shown in FIG. 3, object C element 306 can be moved “on top” of elements 308 and 310, thereby indicating that the element 306 is more important than element 308, which is, in turn, more important than element 310.

In some implementations, whenever an element is moved and/or interacted with on the user interface, the element can be moved “on top” of other elements (either automatically and/or manually). The topmost element can be the ones that have been interacted with mostly and/or can be considered to be most important based on the element's technical depth. In some implementations, the current subject matter can use information about elements located in proximity of an element to determine importance of that element in relation to the other elements. The following exemplary, non-limiting pseudo-code can be used by the processor to define importance of an element to be displayed on the user interface:

```
deriveImportance = function (itemsNearby) {
  for (i = 0; i < itemsNearby.length; i++) {
    allOtherItems = itemsNearby.remove(itemsNearby [i]);
    sizeImportanceFactor = itemsNearby [i].
    compareSizeWith(allOtherItems);
    depthImportanceFactor = itemsNearby [i].
    compareDepthWith(allOtherItems);
  }
}
Item.compareSizeWith = function (items) {
  sizeImportance = 0;
  for (i = 0; i < items.length; i++) {
    if (this.size > items[i].size) {
      sizeImportance += this.size / items[i].size;
    }
  }
  return sizeImportance / items.length;
}
  Item.compareDepthWith(items) {
    depthImportance = 0;
    for (i = 0; i < items.length; i++) {
      depthImportance++;
    }
    return depthImportance;
  }
```

In some implementations, the current subject matter can use order of elements to position the elements on the user interface. For example, some elements displayed on the user interface can be positioned in a particular order. Ordering of elements can be made dependent on importance of elements, priority of elements, and/or any other factors. The order of elements can be based on a clustering of elements, positioning of the elements within clusters, positioning of clusters, etc., and/or any combination thereof.

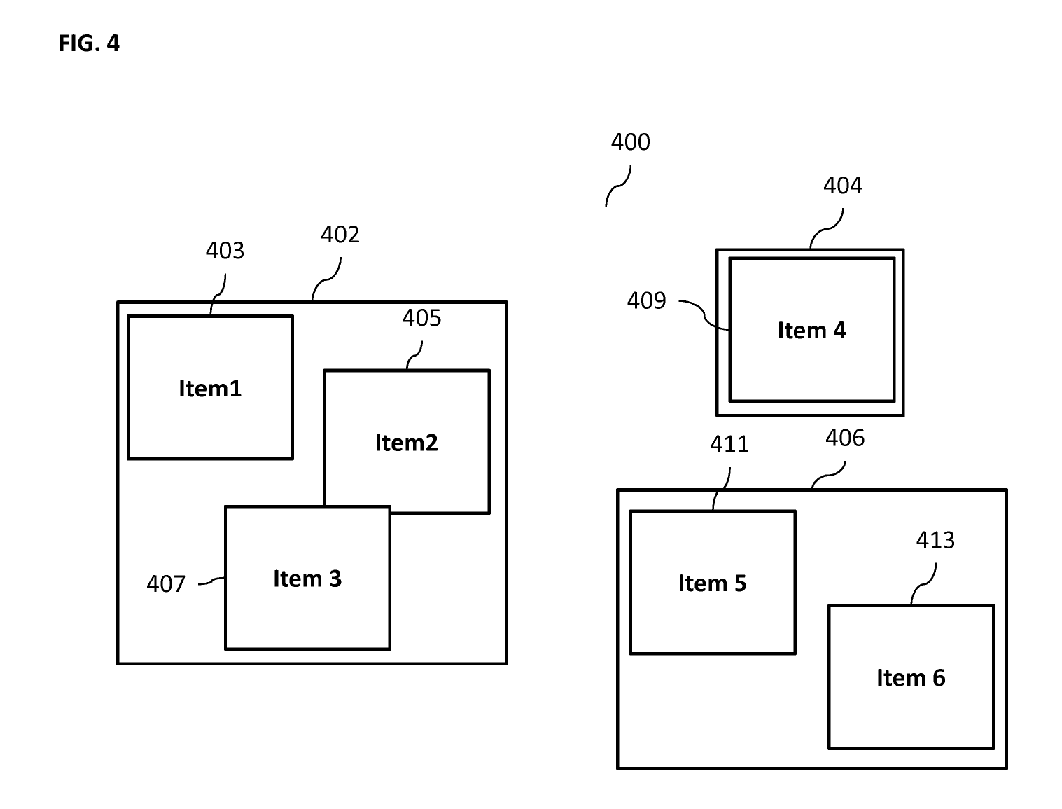

FIG. 4 illustrates an exemplary user interface 400 (similar to user interface 104 shown in FIG. 1) displaying a plurality of elements in an ordered fashion. The elements can be positioned in a left-to-right order, top-to-bottom order, and/or any other order and/or any combination thereof. As shown in FIG. 4, the user interface 400 can include a cluster 402, a cluster 404, and a cluster 406. The cluster 402 can contain item1 element 403, item2 element 405, and item3 element 407. In cluster 402, elements 405 and 407 can collide within another (similar to elements 205 and 207 shown in FIG. 2) and element 403 can be related to elements 405 and 407 without colliding with them. The cluster 404 can contain item4 element 409. As shown in FIG. 4, no other elements are present in the cluster 404. The cluster 406 can contain items element 411 and item6 element 413. Elements 411 and 413 do not collide with one another, but can be placed in a single cluster to indicate relationship among these elements (similar to elements shown in FIG. 2).

In some implementations, clusters 402-406 can be positioned on the user interface 400 in particular order, i.e., cluster 402 can be positioned on the left side of the user interface 400, cluster 404 can be positioned in a top right corner of the user interface 400 (to the right of the cluster 402 and above cluster 406), and cluster 406 can be positioned in a bottom left corner of the user interface 400. Such positioning can be indicative of a particular order of importance of the clusters and/or elements contained within the clusters, e.g., item1 in cluster 402 may need to be attended to first, whereas item6 in cluster 406 may need to be attended to last. Further, positioning of elements within the clusters can also be indicative an order, e.g., in cluster 402, element 403 is positioned to the left of the elements 405 and 407, where element 405 is positioned on top of the element 407 (which can be indicative of an order and/or importance of elements). The following exemplary, non-limiting pseudo-code can be used to define order of elements on the user interface:

```
deriveOrder = function (items) {
  groups = [ ]
  // transform items into groups
while(items.length > 0) {
    for (i = 0; i < items.length; i++) {
    allOtherItems = items.remove(items[i]);
    collisions = calculateCollision(items[i], allOtherItems, 0);
    // 0px threshold
    groups.add(collisions);
    items.remove(collisions)
  }
}
  // calculate an order for the items in a group
  orderedGroups = [ ]
  for (i = 0; i < groups.length; i++) {
  orderedGroups .add(groups[i].sortByPosition( ));
  }
  // calculate an order for all groups
  return orderedGroups.sortByPosition( );
}
Items.sortByPosition = function ( ) {
  // sorts items by position (compare x and y value)
  return sortedItems;
}
```

In some implementations, structuring elements (e.g., groups, lines, associations (arrows, connections, etc.), headlines, sprites, etc.) can be used to determine semantics from the elements placed on the user interface. Such structuring items can be useful in organizing elements on the user interface (e.g., several users wanting to brainstorm a particular topic can add elements representative of ideas, references to other material(s), contact information for various entities (e.g., companies, individuals, etc.), links to web pages, etc.). The structuring of elements can also allow for sorting of elements, where the elements can be positioning directly using structuring elements, as discussed below.

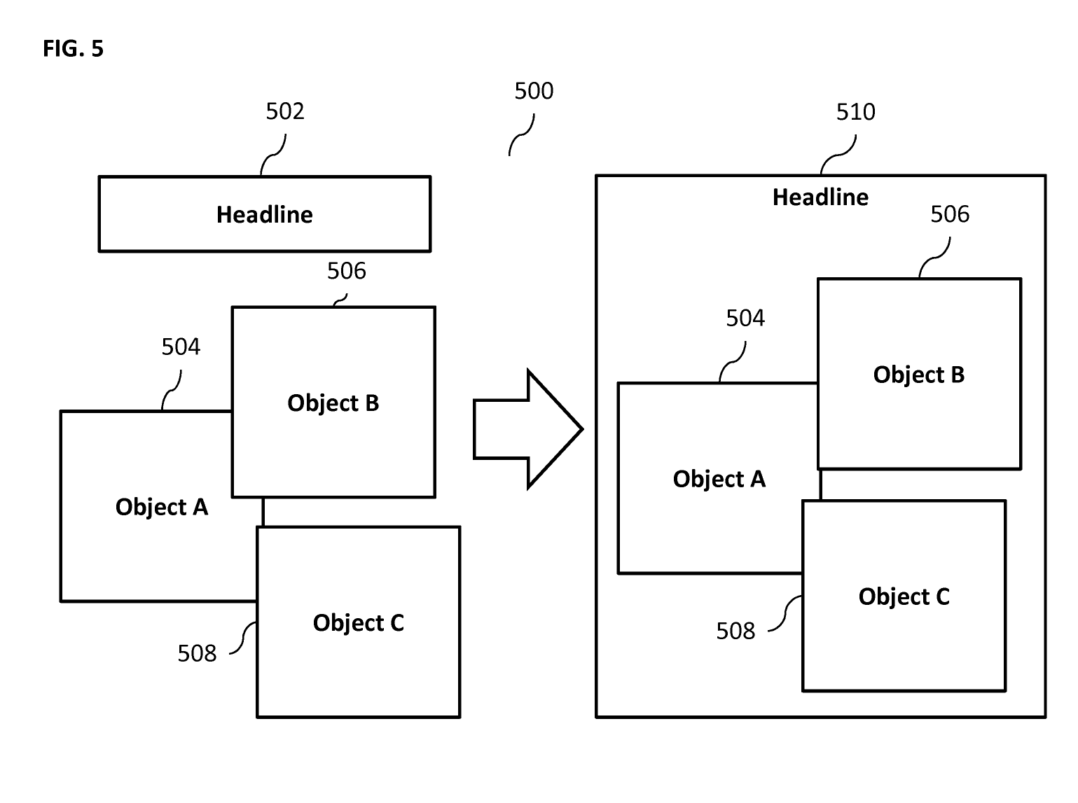

FIG. 5 illustrates an exemplary user interface 500 for grouping (i.e., a structuring element) various elements, according to some implementations of the current subject matter. The elements can be grouped into a group 510 using a “headline” group element 502. As shown in FIG. 5, object A element 504, object B element 506, and object C element 508 (for example, as shown in FIG. 5, element 504 can be intersecting or “colliding” with both elements 506 and 508) can be semantically clustered under the headline 502. In view of such clustering, the group 510 can be created to encompass the three elements 504-508 as well as the headline 502. In some implementations, in order to group the elements 504-508 under the headline element 502, the headline element 502 and the elements 504-508 can be positioned in a relative proximity to one another on the user interface 500.

For example, the headline element 502 can include a text that can identify semantics of the ideas (as contained within elements 504-508) that can be positioned closely together, whereby a group relationship can be determined automatically and/or manually. The headline and the three ideas can be transformed into a group using the text contained in the headline element and the items can be put inside the group, as shown by the group 510. The group 510 can be moved and rearranged as a single element, where the group 510 can also be used to further define more complex semantics later on. The following exemplary, non-limiting pseudo-code can be used by the server 106 (shown in FIG. 1) to generate grouping of elements:

```
deriveGroup = function (itemsNearby) {
  group;
  group.name = “new group”;
  for (i = 0; i < itemsNearby.length; i++) {
    allOtherItems = itemsNearby.remove(itemsNearby [i]);
    neighbors = calculateCollision(itemsNearby [i], allOtherItems, 50);
    // 50px threshold
    for (j = 0; j < neighbors.length; j++) {
      if (neighbors[i].isA(“Headline”) {
        group.name = neighbors[i].text;
      } else {
        group.addItem(neighbors [i]);
      }
    }
  }
    return group;
  }
```

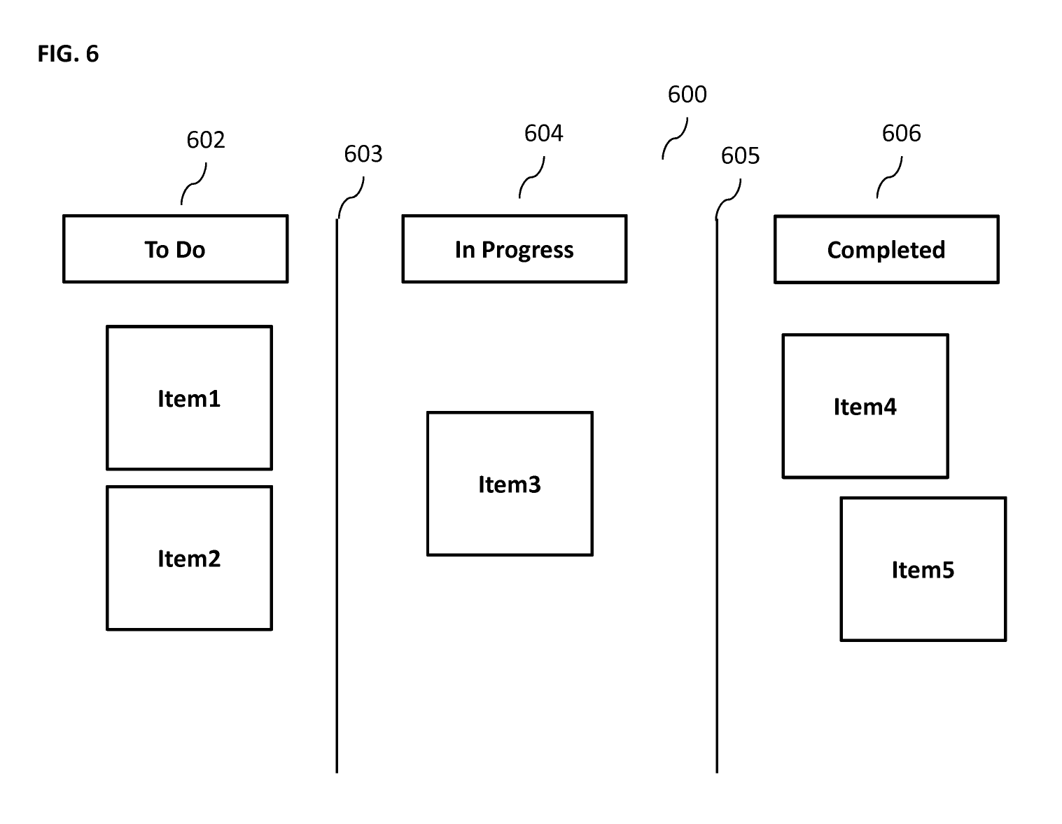

FIG. 6 illustrates an exemplary user interface 600 containing sectioning structuring elements, according to some implementations of the current subject matter. In some implementations, the user interface can be divided and/or sectioned into one or more sections where various elements can be placed. The user interface can be sectioned using a line graphical element. In some implementations, the line graphical element can be a visual tool that can be used to divide the space on the area in vertical, horizontal, and/or any other ways and/or dimensions. The result of such divisions can include subsections of the user interface that can contain items having semantic relationships.

As shown in FIG. 6, the user interface 600 can be divided into three sub-sections 602, 604, and 606 using vertical lines 603 (dividing user interface 600 into sections 602 and 604) and 605 (dividing user interface 600 into sections 604 and 606). In the exemplary user interface 600, section 602 can correspond to a list of “To Do” items that the user may wish to complete (e.g., Item1, Item2). Section 604 can include a list of items that are “In Progress” (e.g., Item3). Section 606 can include a list of items that are “Completed” (e.g., Item4, Item5). In some implementations, a section (e.g., sections 602-606) can be a space between two lines (e.g., lines 603, 605) and can be ascertained by analyzing all lines on the user interface. The sections can be ascertained based on x and/or y coordinates (and/or any other position identification elements) of the separation elements (i.e., lines 603, 605). Thus, by analyzing the x coordinates of the items (i.e., Item1, Item2, Item3, Item4, and Item5) and the lines 603, 605 (assuming the user interface 600 has a width of 1000 units) and assuming that the lines 603, 605 divide the user interface 600 into three equal portions, as shown in FIG. 6, elements (i.e., Item1, Item2) located between x=0 units and x=333 units can be determined to be located in the first section 602, elements (i.e., Item3) located between x=334 units and x=666 units can be determined to be located in the second section 604, and elements (i.e., Item4, Item5) located between x=667 units and x=1000 units can be determined to be located in the third section 606.

In some implementations, the user interface 600 can include a plurality of sections as well as subsections located within a section and/or spanning one or more sections. The elements within sections and/or subsections can be determined to be located within a section, a subsection, and/or spanning one or more sections and/or subsections. The elements located within sections/subsections can be organized in any fashion, in accordance with the discussion in the present application (e.g., groups, colliding elements, clustered, etc.). By analyzing elements in a section, elements (e.g., objects, groups, headlines, etc.) can be identified in relation on the section/subsection, thereby providing the section a more semantic relation. The following exemplary, non-limiting pseudo-code can be used by the server 106 (shown in FIG. 1) to generate sections (as shown below, the code is for determining horizontal sections, but can be modified to determine horizontal and/or vertical and/or both or other types of sections):

```
deriveSectionsHorizontally = function (items) {
  sections = [ ];
  sortedItemsByXCoordinate = items.sort(“x”);
  sortedLinesByXCoordinate = sortedItemsByXCoordinate.filter(“Line”);
  for (i = 0; i < sortedLinesByXCoordinate.length − 1; i++) {
    startX = sortedLinesByXCoordinate[i].x;
    endX = sortedLinesByXCoordinate[i + 1].x;
    for (j = 0; j < sortedItemsByXCoordinate.length; j++) {
      if (sortedItemsByXCoordinate[j].x > startX &&
      sortedItemsByXCoordinate.x < endX) {
        sections[i].add(sortedItemsByXCoordinate[j]);
      }
    }
  }
  return sections;
}
```

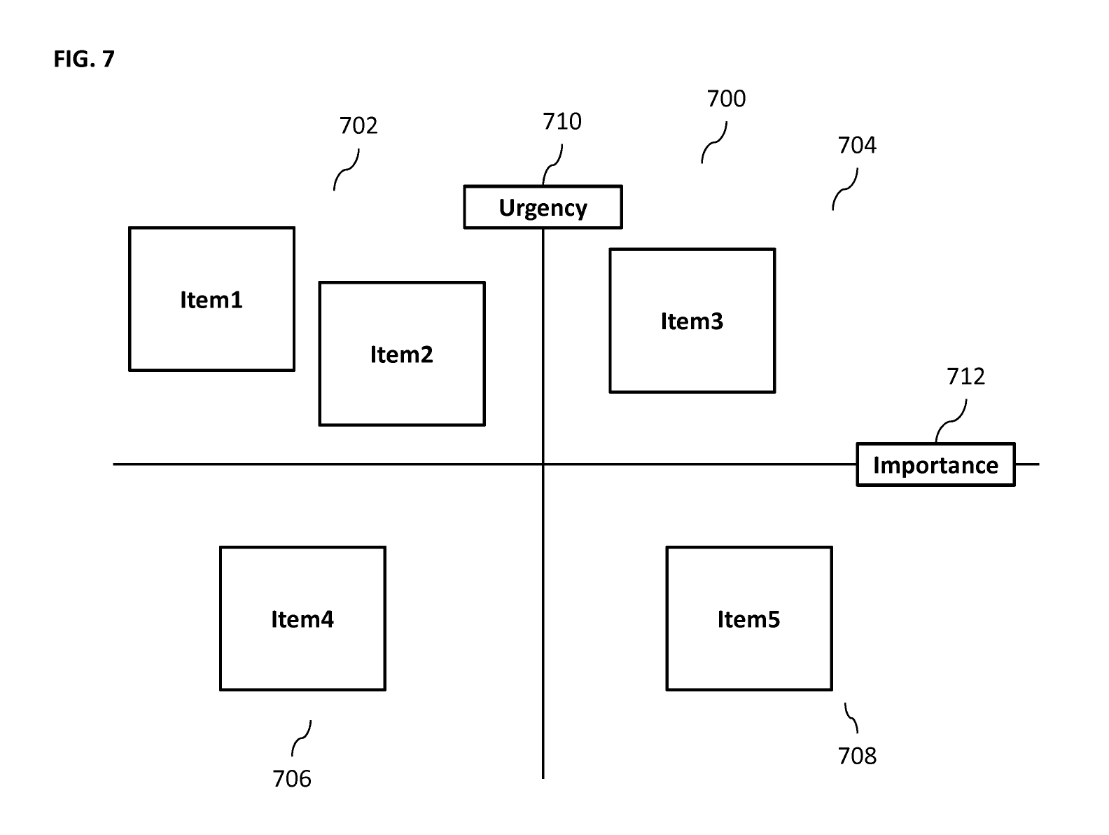

FIG. 7 illustrates an exemplary an exemplary user interface 700 containing further sectioning structuring elements, such as axes and/or quadrants, according to some implementations of the current subject matter. In some implementations, the user interface can be divided and/or sectioned into one or more quadrants where various elements can be placed. The user interface can be sectioned using one or more line graphical elements (similar to FIG. 6). In some implementations, the line graphical elements can be used to divide the user interface into vertical, horizontal, and/or any other ways and/or dimensions. The result of such divisions can include subsections of the user interface that can contain items having semantic relationships. By analyzing x and y coordinates of the lines, semantic areas that contain various elements, can be ascertained and the elements contained within a particular subsection can be identified.

As shown in FIG. 7, the user interface 700 can be divided into four subsections 702, 704, 706, and 708 by two axes “Urgency” vertical axis 710 and “Importance” horizontal axis 712. Elements (e.g., Item3) located in subsection 702 can be determined to be most urgent and most important, whereas elements (e.g., Item4) located in subsection 706 can be determined to be least urgent and least important. The elements located in each subsection can be organized in any fashion, in accordance with the discussion in the present application (e.g., groups, colliding elements, clustered, etc.). Coordinates of elements within subsections, coordinates of the dividing lines, as well as coordinates of the subsections themselves, can be used to generate a table that can contain dimensions “Urgency” and “Importance”, as shown in FIG. 7. This can further define a semantic chart, where elements (e.g., Items 1-5) can be mapped according to their positions. Additional vertical and/or horizontal lines can generate more detailed subsections where elements can be further categorized. In some implementations, such semantic relationships can used to define various business objects and/or processes. The following exemplary, non-limiting pseudo-code can be used by the server 106 (shown in FIG. 1) to generate subsections shown in FIG. 7:

```
deriveAxisValues = function (items) {
  axises= [ ];
  lines = items.filter(“Line”);
  // find axises
  for (i = 0; i < lines.length; i++) {
    collisions = calculateCollision(itemsNearby [i], allOtherItems, 0);
    // 0px threshold
    for (j = 0; j < collisions.length; j++) {
      if (collisions[j].isA(“Headline”) {
        axis.name = collisions[j].text;
        axis.line = lines[i];
        axis.orientation = lines[i].orientation; // horizontal or vertical
        axises.add(axis);
      }
    }
  }
  // calculate item values
  for (i = 0; i < items.length; i++) {
    for (j = 0; j < axises.length; j++) {
      if (axises[j].orientation == “horizontal”) {
          // calculate axis value based on the x coordinate of the item
        } else {
      // calculate axis value based on the y coordinate of the item
    }
  }
    // or, similar to code above, find items that are in a specific section
    between the axises
  }
```

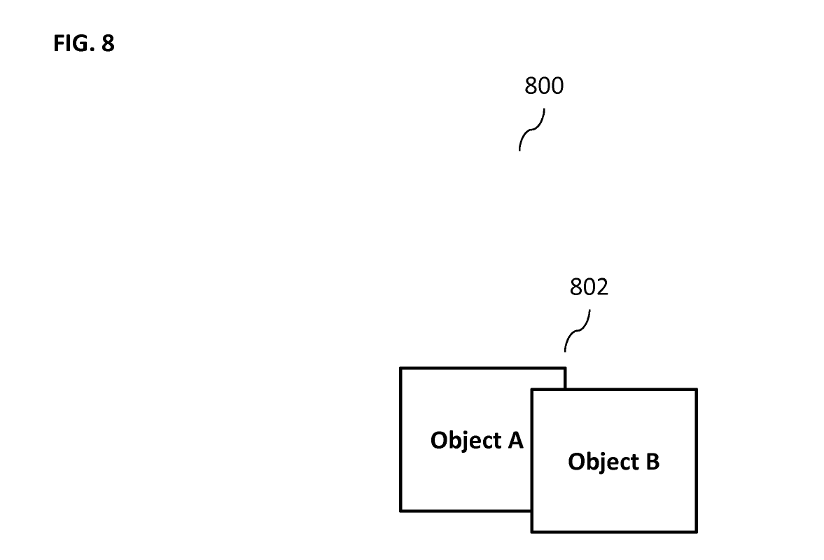

FIG. 8 illustrates an exemplary user interface 800 that can indicate a parent-child relationship between one or more elements, according to some implementations of the current subject matter. The parent-child relationship between elements can be indicative of a close relationship between the elements (e.g., as shown in FIG. 8, Object A can correspond to an idea, where Object B can correspond to a person who generated the idea). Moreover, in view of the close relationship between the elements, operations affecting one element can equally affect the other element (e.g., when a parent element is moved, the child element is also moved; when the parent is deleted, the child is also deleted, etc.). The relationship between elements can be that of a collision semantic relationship (e.g., as shown in FIG. 2), where the child semantic is defined. The relationships between elements can be defined by the user manually and/or by the system based on the analysis of content of the elements that are linked together (e.g., idea-person, idea-link, text-document, video-comment, etc.). One or more child elements can be related to the same parent or multiple different parents. One element can correspond to a root element of a hierarchy of child, grandchild, etc. elements.

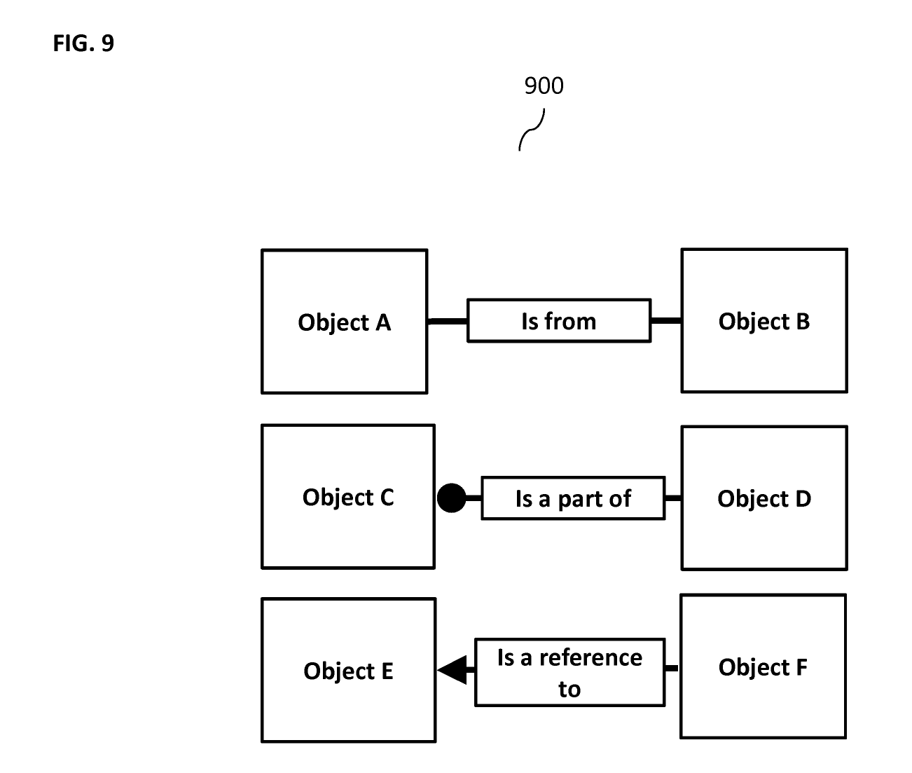

FIG. 9 illustrates an exemplary user interface 900 that can indicate association relationship among elements, according to some implementations of the current subject matter. The association relationship semantics can be defined by drawing a line between two elements (e.g., as shown in FIG. 9, “Object A” “is from” “Object B”; “Object C” “is part of” “Object D”; and “Object E” “is a reference to” “Object F”). The association relationship can be a weaker coupling of two elements than a parent-child relationship shown in FIG. 8. The elements can depend on each other, as shown in FIG. 9, however, the elements can be separate instances that can still be re-arranged on their own as well as operations performed with regard to one element might not necessarily affect the other elements with which the former is associated with. In some implementations, association can be implemented as a connection using a predetermined semantic relationship between two elements. Similar to the other semantic relationships, a text element and/or a headline element on related to the connection line can provide more meaning to the relationship. In some implementations, the association of elements can be ascertained using x and y coordinates of the elements themselves as well as the association elements (e.g., “is from”, “is part of”, etc.).

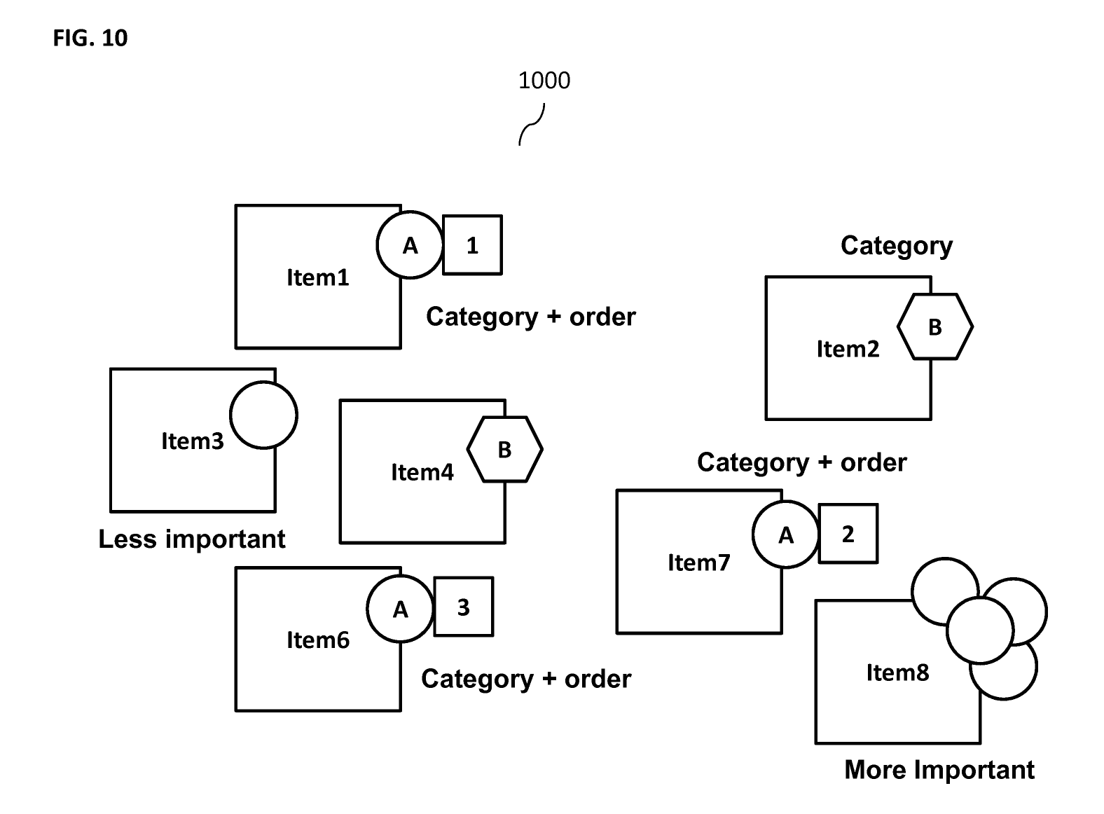

FIG. 10 illustrates an exemplary user interface 1000 that can indicate categorization semantic relationship among elements, according to some implementations of the current subject matter. The categorization semantic relationship can be applied by adding a child to an item along with a predetermined semantic meaning A “sprite” element containing a short text (e.g., a letter, a number, etc.), a different color code, a shape, etc. can be used to define such categorization semantic relationship. The sprite element can define a categorization semantic relationship by: adding a letter element to an element as a child to categorize elements in a particular category (e.g., item2 with a sprite B (having a hexagonal shape), as shown in FIG. 10); adding a number element to re-define an order of elements (e.g., item1 with a sprite A (having a circular shape) and a sprite 1 (having a square shape), where sprite 1 element follows sprite A element, which in turn, follows item1 element, as shown in FIG. 10); and adding color codes and/or different shapes to an element in order to create a relationship between elements within the same category (e.g., item3 with a circular sprite, as shown in FIG. 10).

Additionally, the categorization semantic relationship can be used to define importance of an element. For example, in a dot voting in design-thinking workshops, colored dots can be placed on elements to define their importance. The more dots an element has (e.g., item 8, as shown in FIG. 10), the more important the element can be. Fewer dots (e.g., item 3, as shown in FIG. 10), the less important the element can be. In some implementations, analysis of a number of sprites on an element can determine importance of the element. The following exemplary, non-limiting pseudo-code can be used by the server 106 (shown in FIG. 1) to add a categorization semantic relationship using sprites as shown in FIG. 10:

```
deriveCategory = function (items) {
  categories = [ ];
  for(i=0; i < items.length; i++) {
    for (j=0; j< items[i].categories.length; j++) {
      category.name = items[i].categories.[j].text;
      category.items.add(items[i];
      // find items with the same category by iterating through all
      items again
      for (k = 0...) {
        if(items[k].categories[l] == category[j]) {
          category.add(items[k]);
        }
      }
      categories.add(category);
    }
  }
```

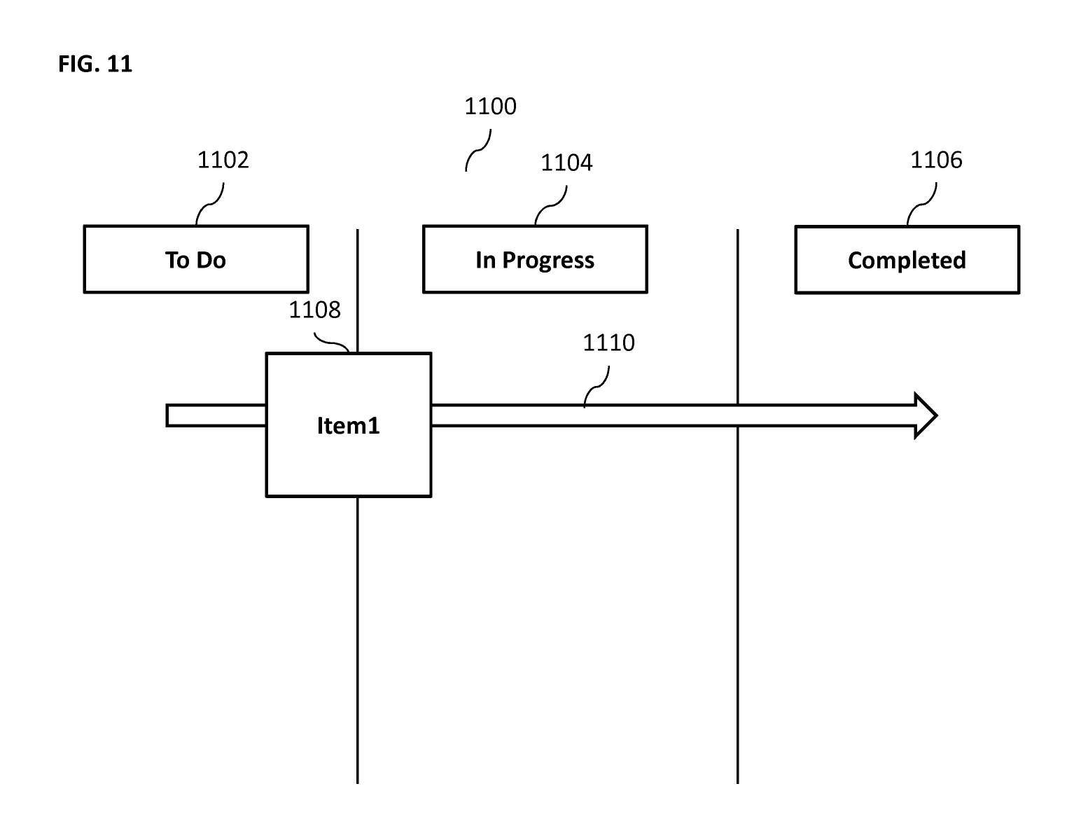

FIG. 11 illustrates an exemplary user interface 1100 for combining implicit and/or explicit semantic relationships, such as for the purposes of determining information from the content, according to some implementations of the current subject matter. FIG. 11 (similar to FIG. 6) includes three sections 1102 (“To Do”), 1104 (“In Progress”), and 1106 (“Completed”) that are separated by vertical line elements. Item1 1108 can be in a process of being transitioned from the section 1102 (“To Do”) to section 1104 (“In Progress”) and eventually to the section 1106 (“Completed”) as indicated by the arrow element 1110. In some implementations, the current subject matter allows analysis of elements contained on the user interface 1100 and their semantic relationships can be based on one or more implicit semantic relationships (e.g., relation, importance, order, section, child, association, category, etc.). For example, as shown in FIG. 11, the current subject matter can detect when an element is being moved from one from one group to another group or when the element is proximately located to other elements on the user interface. Upon detection of the movement, changes in various semantic relationships associated with the element being moved can be determined. In some exemplary implementations, various analytical functions can be used to detect how many important ideas and/or tasks are defined on the user interface and collect additional information on the overall semantics of the user interface.

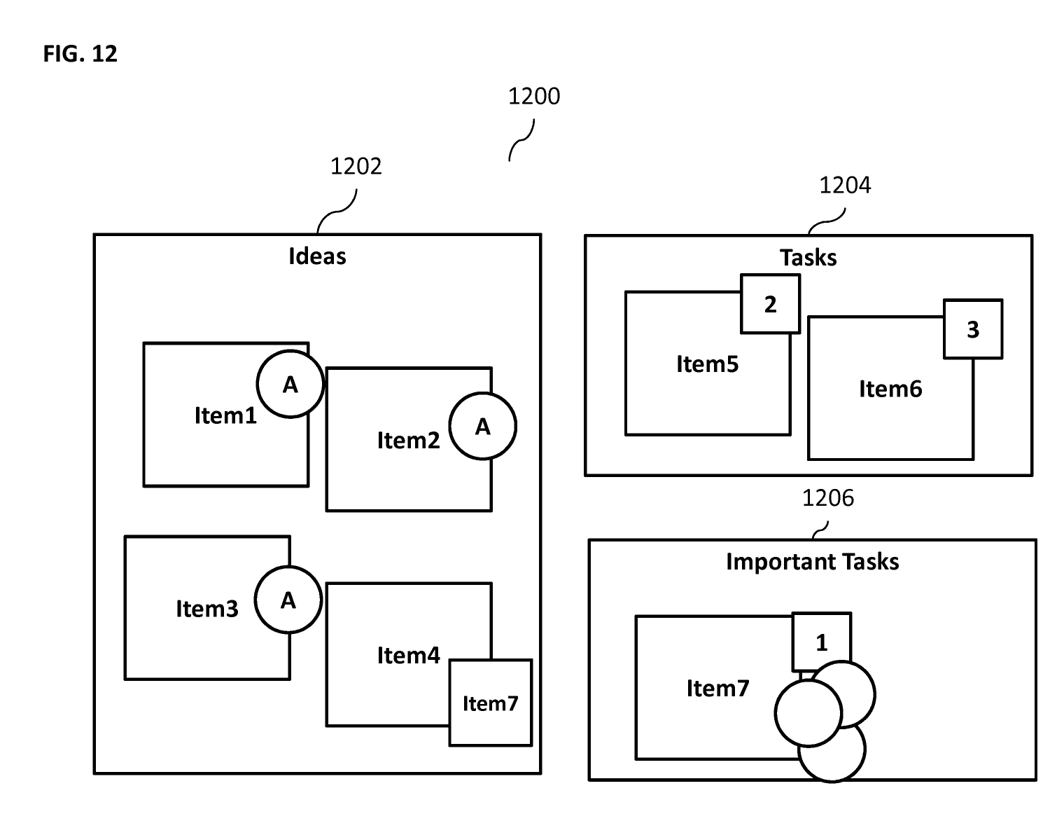

FIG. 12 illustrates an exemplary user interface 1200 that can provide grouping and/or clustering of elements, according to some implementations of the current subject matter. For example, elements can be grouped using the “relation”, “category”, “importance”, etc. semantic relationships to generate groups of elements that can be further processed to determine various element associations. As shown in FIG. 12, elements (e.g., items 1-7) can be grouped in accordance with “ideas” group element 1202, “tasks” group element 1204, and “important tasks” group element 1206. Within each group element, elements that can be arranged in particular fashion having various semantic relationships discussed above.

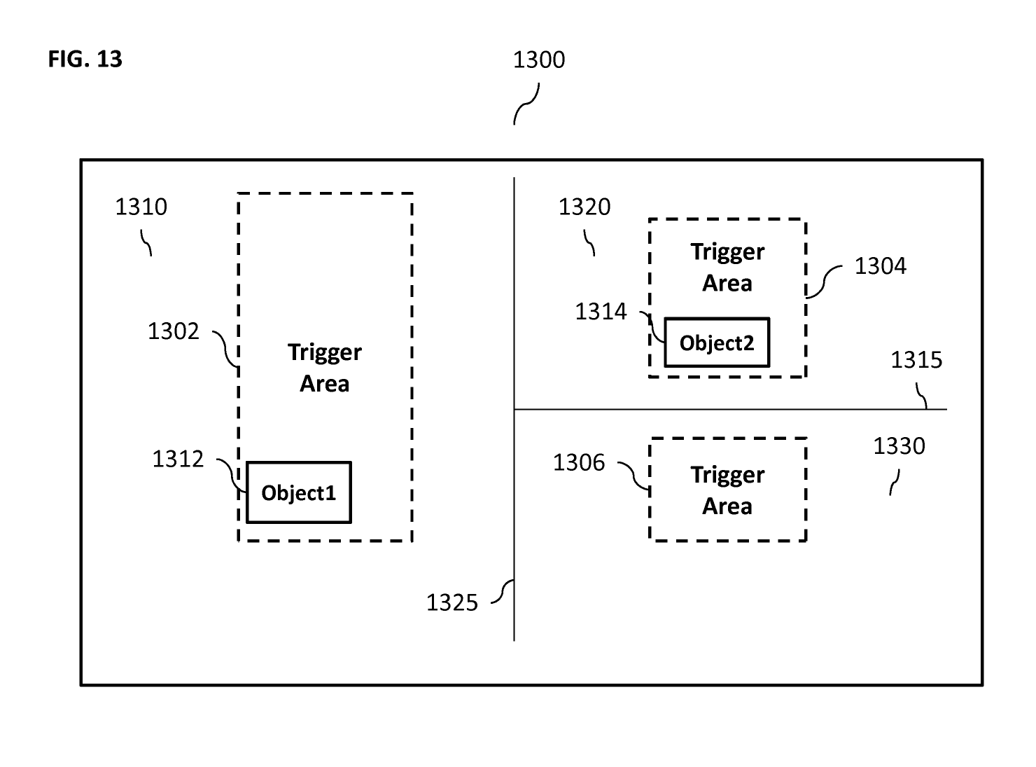

FIG. 13 illustrates an exemplary user interface 1300 that can define trigger areas and/or actions. The semantic relationships can be predetermined by generating trigger areas on the user interface. When an element is added and/or removed to/from a trigger area having a particular “group” semantic relationship, a predefined action can be executed (e.g., updating a status of a field in other systems).

As shown in FIG. 13, the user interface 1300 can include predetermined sections 1310, 1320, and 1330 (similar to sections shown in FIGS. 6-7). The sections can be separated by structural elements (e.g., lines) 1315 and 1325 (similar to lines shown in FIGS. 6-7). For example, the line 1325 can separate section 1310 from sections 1320 and 1330; and line 1315 can separate sections 1320 and 1330. Each section 1310, 1320, and 1330 can include one or more trigger areas that can be used to trigger execution of various actions based on placement of elements containing various semantic relationship and/or identifiers. For example, section 1310 can include a trigger area 1302; section 1320 can include a trigger area 1304; and section 1330 can include a trigger area 1306. Each section can have one or more trigger areas or none at all. The trigger areas can span one or more sections. The sections and trigger areas can have any shape and/or size and can be used to define any type of actions that may be executed. As stated above, the trigger areas can accommodate placement of various elements (e.g., content objects and/or any elements discussed above with regard to FIGS. 2-12). As shown in FIG. 13, an object1 element 1312 is placed on the trigger area 1302; an object2 element 1314 can be placed on the trigger area 1304, etc. Placement of objects on one more trigger areas may or may not cause execution of a specific operation. Any number of elements can be placed into the trigger areas. Further, placement of elements in a proximity of the trigger area (e.g., outside of the trigger area, and/or partially spanning the trigger area and the outside of the trigger area, etc.) may also cause execution of particular operation. Addition, movement, and/or any other operation on any of these objects can trigger various operations (e.g., creation of other objects in the same or different areas, deletion of objects, movement of objects, etc.) in the user interface 1300. The trigger areas can include detection mechanism that can determine action performed on a particular element (whether or not in the same area) and ascertain whether or not another action may need to be performed (whether or not in the same area).

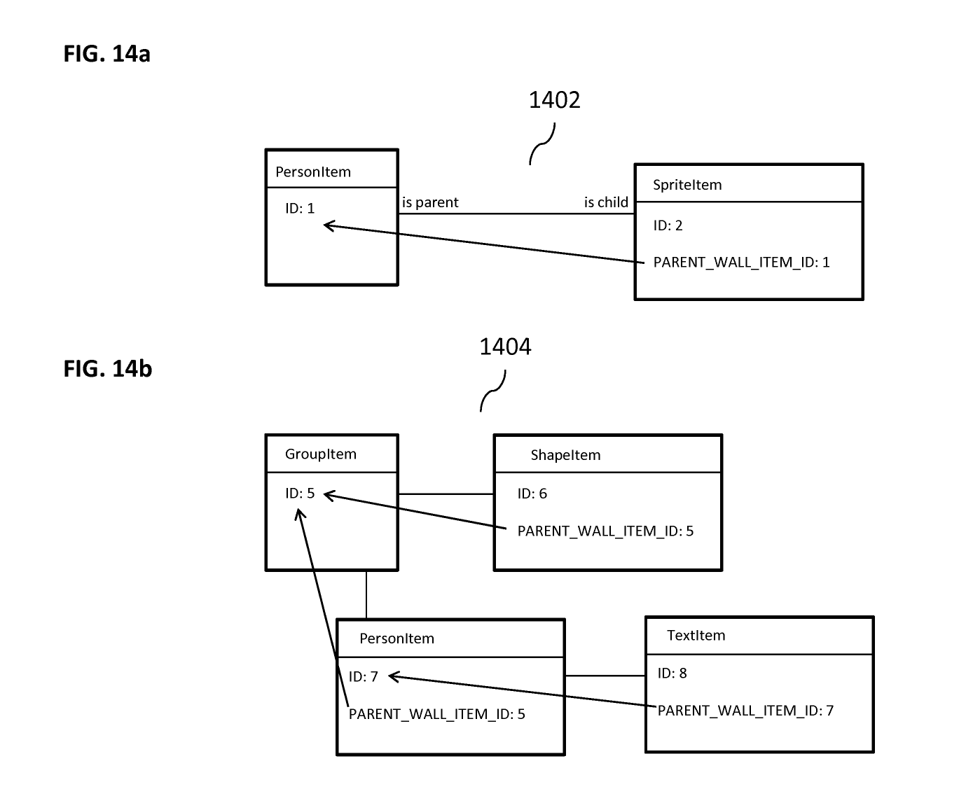

In some implementations, the information associated with particular elements being manipulated on a user interface can be stored in memory (e.g., database 108 as shown in FIG. 1). FIGS. 14a-b illustrate exemplary ways of arranging storage of such information. As shown in FIG. 14, the association 1402 illustrates an exemplary “PersonItem” having an identifier “ID: 1” being a parent of a “SpriteiItem” having an identifier “ID: 2”, where the child SpriteiItem includes a reference to its parent item by including the following string “PARENT_WALL_ITEM_ID: 1”. FIG. 14b illustrates an exemplary “GroupItem” having an identifier “ID: 5” being containing a child of a “PersonItem” having an identifier “ID: 7”. The PersonItem can also include a reference to the GroupItem by including the following string “PARENT_WALL_ITEM_ID: 5”. Moreover, the GroupItem can also be associated with a “ShapeItem” element having an identifier “ID: 6” and also including a reference string of “PARENT_WALL_ITEM_ID: 5” to the GroupItem. The PersonItem can be associated with a “TextItem” having an identifier “ID: 8”, where the TextItem includes a reference to the PersonItem by including a string of “PARENT_WALL_ITEM_ID: 7”. The strings and identifiers can be in a column format (and/or a row format and/or a column-row format) in a database table and can be accessed upon operations being performed on the elements.

In some implementations, the current subject matter can be implemented in various in-memory database systems, such as a High Performance Analytic Appliance (“HANA”) system as developed by SAP SE, Walldorf, Germany. Various systems, such as, enterprise resource planning (“ERP”) system, supply chain management system (“SCM”) system, supplier relationship management (“SRM”) system, customer relationship management (“CRM”) system, and/or others, can interact with the in-memory system for the purposes of accessing data, for example. Other systems and/or combinations of systems can be used for implementations of the current subject matter. The following is a discussion of an exemplary in-memory system.

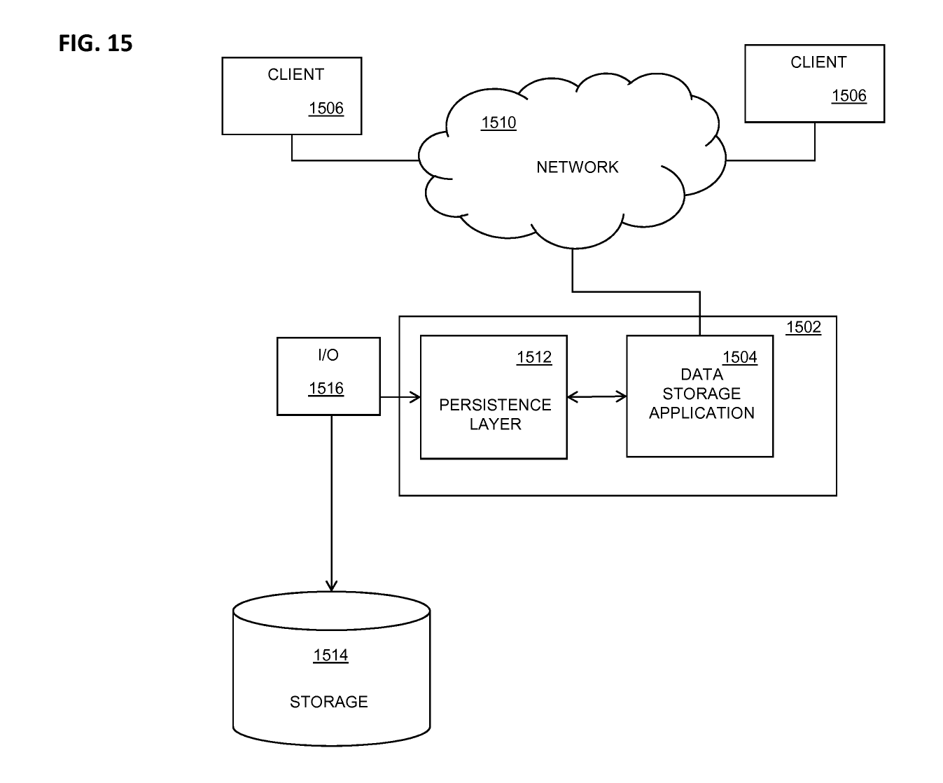

FIG. 15 illustrates an exemplary system 1500 in which a computing system 1502, which can include one or more programmable processors that can be collocated, linked over one or more networks, etc., executes one or more modules, software components, or the like of a data storage application 1504, according to some implementations of the current subject matter. The data storage application 1504 can include one or more of a database, an enterprise resource program, a distributed storage system (e.g. NetApp Filer available from NetApp of Sunnyvale, Calif.), or the like.

The one or more modules, software components, or the like can be accessible to local users of the computing system 1502 as well as to remote users accessing the computing system 1502 from one or more client machines 1506 over a network connection 1510. One or more user interface screens produced by the one or more first modules can be displayed to a user, either via a local display or via a display associated with one of the client machines 1506. Data units of the data storage application 1504 can be transiently stored in a persistence layer 1512 (e.g., a page buffer or other type of temporary persistency layer), which can write the data, in the form of storage pages, to one or more storages 1514, for example via an input/output component 1516. The one or more storages 1514 can include one or more physical storage media or devices (e.g. hard disk drives, persistent flash memory, random access memory, optical media, magnetic media, and the like) configured for writing data for longer term storage. It should be noted that the storage 1514 and the input/output component 1516 can be included in the computing system 1502 despite their being shown as external to the computing system 1502 in FIG. 15.

Data retained at the longer term storage 1514 can be organized in pages, each of which has allocated to it a defined amount of storage space. In some implementations, the amount of storage space allocated to each page can be constant and fixed. However, other implementations in which the amount of storage space allocated to each page can vary are also within the scope of the current subject matter.

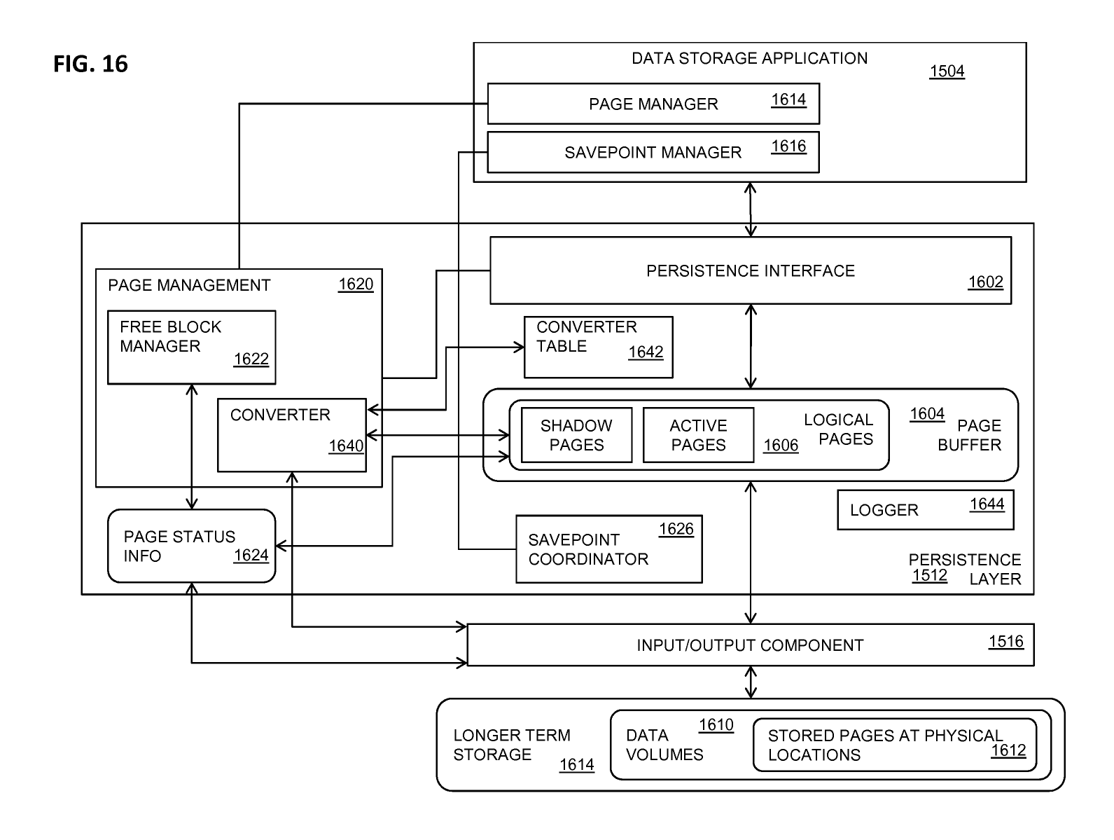

FIG. 16 illustrates exemplary software architecture 1600, according to some implementations of the current subject matter. A data storage application 1504, which can be implemented in one or more of hardware and software, can include one or more of a database application, a network-attached storage system, or the like. According to at least some implementations of the current subject matter, such a data storage application 1504 can include or otherwise interface with a persistence layer 1512 or other type of memory buffer, for example via a persistence interface 1602. A page buffer 1604 within the persistence layer 1512 can store one or more logical pages 1606, and optionally can include shadow pages, active pages, and the like. The logical pages 1606 retained in the persistence layer 1512 can be written to a storage (e.g. a longer term storage, etc.) 1514 via an input/output component 1516, which can be a software module, a sub-system implemented in one or more of software and hardware, or the like. The storage 1514 can include one or more data volumes 1610 where stored pages 1612 are allocated at physical memory blocks.

In some implementations, the data storage application 1504 can include or be otherwise in communication with a page manager 1614 and/or a savepoint manager 1616. The page manager 1614 can communicate with a page management module 1620 at the persistence layer 1512 that can include a free block manager 1622 that monitors page status information 1624, for example the status of physical pages within the storage 1514 and logical pages in the persistence layer 1512 (and optionally in the page buffer 1604). The savepoint manager 1616 can communicate with a savepoint coordinator 1626 at the persistence layer 1512 to handle savepoints, which are used to create a consistent persistent state of the database for restart after a possible crash.

In some implementations of a data storage application 1504, the page management module of the persistence layer 1512 can implement a shadow paging. The free block manager 1622 within the page management module 1620 can maintain the status of physical pages. The page buffer 1604 can include a fixed page status buffer that operates as discussed herein. A converter component 1640, which can be part of or in communication with the page management module 1620, can be responsible for mapping between logical and physical pages written to the storage 1514. The converter 1640 can maintain the current mapping of logical pages to the corresponding physical pages in a converter table 1642. The converter 1640 can maintain a current mapping of logical pages 1606 to the corresponding physical pages in one or more converter tables 1642. When a logical page 1606 is read from storage 1514, the storage page to be loaded can be looked up from the one or more converter tables 1642 using the converter 1640. When a logical page is written to storage 1514 the first time after a savepoint, a new free physical page is assigned to the logical page. The free block manager 1622 marks the new physical page as “used” and the new mapping is stored in the one or more converter tables 1642.

The persistence layer 1512 can ensure that changes made in the data storage application 1504 are durable and that the data storage application 1504 can be restored to a most recent committed state after a restart. Writing data to the storage 1514 need not be synchronized with the end of the writing transaction. As such, uncommitted changes can be written to disk and committed changes may not yet be written to disk when a writing transaction is finished. After a system crash, changes made by transactions that were not finished can be rolled back. Changes occurring by already committed transactions should not be lost in this process. A logger component 1644 can also be included to store the changes made to the data of the data storage application in a linear log. The logger component 1644 can be used during recovery to replay operations since a last savepoint to ensure that all operations are applied to the data and that transactions with a logged “commit” record are committed before rolling back still-open transactions at the end of a recovery process.

With some data storage applications, writing data to a disk is not necessarily synchronized with the end of the writing transaction. Situations can occur in which uncommitted changes are written to disk and while, at the same time, committed changes are not yet written to disk when the writing transaction is finished. After a system crash, changes made by transactions that were not finished must be rolled back and changes by committed transaction must not be lost.

To ensure that committed changes are not lost, redo log information can be written by the logger component 1644 whenever a change is made. This information can be written to disk at latest when the transaction ends. The log entries can be persisted in separate log volumes while normal data is written to data volumes. With a redo log, committed changes can be restored even if the corresponding data pages were not written to disk. For undoing uncommitted changes, the persistence layer 1512 can use a combination of undo log entries (from one or more logs) and shadow paging.

The persistence interface 1602 can handle read and write requests of stores (e.g., in-memory stores, etc.). The persistence interface 1602 can also provide write methods for writing data both with logging and without logging. If the logged write operations are used, the persistence interface 1602 invokes the logger 1644. In addition, the logger 1644 provides an interface that allows stores (e.g., in-memory stores, etc.) to directly add log entries into a log queue. The logger interface also provides methods to request that log entries in the in-memory log queue are flushed to disk.

Log entries contain a log sequence number, the type of the log entry and the identifier of the transaction. Depending on the operation type additional information is logged by the logger 1644. For an entry of type “update”, for example, this would be the identification of the affected record and the after image of the modified data.

When the data application 1504 is restarted, the log entries need to be processed. To speed up this process the redo log is not always processed from the beginning Instead, as stated above, savepoints can be periodically performed that write all changes to disk that were made (e.g., in memory, etc.) since the last savepoint. When starting up the system, only the logs created after the last savepoint need to be processed. After the next backup operation the old log entries before the savepoint position can be removed.

When the logger 1644 is invoked for writing log entries, it does not immediately write to disk. Instead it can put the log entries into a log queue in memory. The entries in the log queue can be written to disk at the latest when the corresponding transaction is finished (committed or aborted). To guarantee that the committed changes are not lost, the commit operation is not successfully finished before the corresponding log entries are flushed to disk. Writing log queue entries to disk can also be triggered by other events, for example when log queue pages are full or when a savepoint is performed.

With the current subject matter, the logger 1644 can write a database log (or simply referred to herein as a “log”) sequentially into a memory buffer in natural order (e.g., sequential order, etc.). If several physical hard disks/storage devices are used to store log data, several log partitions can be defined. Thereafter, the logger 1644 (which as stated above acts to generate and organize log data) can load-balance writing to log buffers over all available log partitions. In some cases, the load-balancing is according to a round-robin distributions scheme in which various writing operations are directed to log buffers in a sequential and continuous manner. With this arrangement, log buffers written to a single log segment of a particular partition of a multi-partition log are not consecutive. However, the log buffers can be reordered from log segments of all partitions during recovery to the proper order.

As stated above, the data storage application 1504 can use shadow paging so that the savepoint manager 1616 can write a transactionally-consistent savepoint. With such an arrangement, a data backup comprises a copy of all data pages contained in a particular savepoint, which was done as the first step of the data backup process. The current subject matter can be also applied to other types of data page storage.

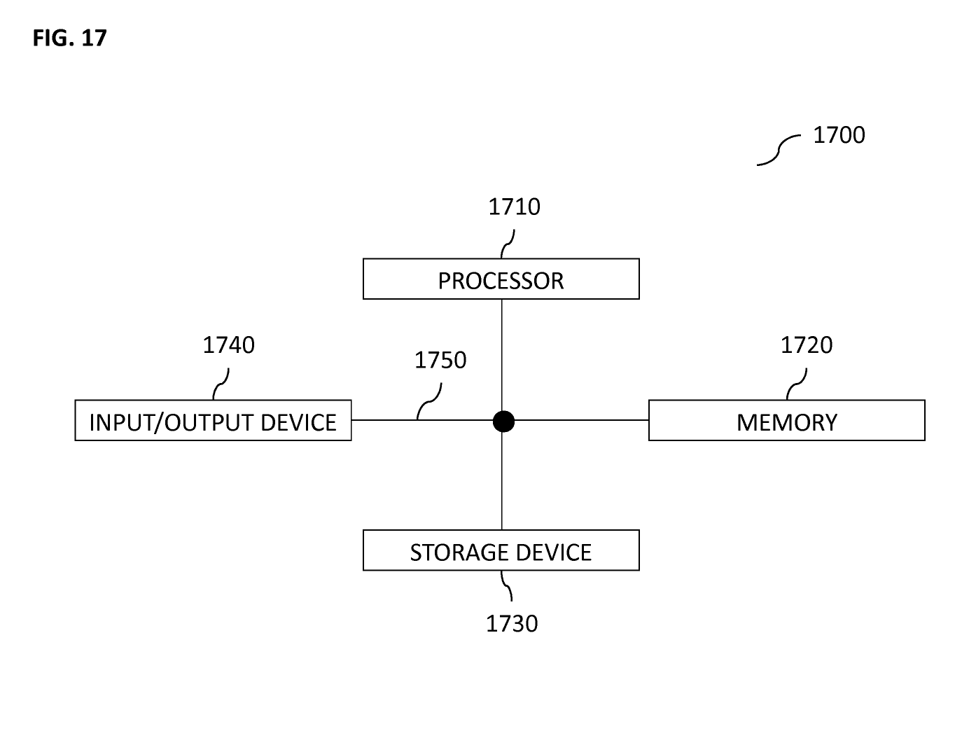

In some implementations, the current subject matter can be configured to be implemented in a system 1700, as shown in FIG. 17. The system 1700 can include a processor 1710, a memory 1720, a storage device 1730, and an input/output device 1740. Each of the components 1710, 1720, 1730 and 1740 can be interconnected using a system bus 1750. The processor 1710 can be configured to process instructions for execution within the system 1700. In some implementations, the processor 1710 can be a single-threaded processor. In alternate implementations, the processor 1710 can be a multi-threaded processor. The processor 1710 can be further configured to process instructions stored in the memory 1720 or on the storage device 1730, including receiving or sending information through the input/output device 1740. The memory 1720 can store information within the system 1700. In some implementations, the memory 1720 can be a computer-readable medium. In alternate implementations, the memory 1720 can be a volatile memory unit. In yet some implementations, the memory 1720 can be a non-volatile memory unit. The storage device 1730 can be capable of providing mass storage for the system 1700. In some implementations, the storage device 1730 can be a computer-readable medium. In alternate implementations, the storage device 1730 can be a floppy disk device, a hard disk device, an optical disk device, a tape device, non-volatile solid state memory, or any other type of storage device. The input/output device 1740 can be configured to provide input/output operations for the system 1700. In some implementations, the input/output device 1740 can include a keyboard and/or pointing device. In alternate implementations, the input/output device 1740 can include a display unit for displaying graphical user interfaces.

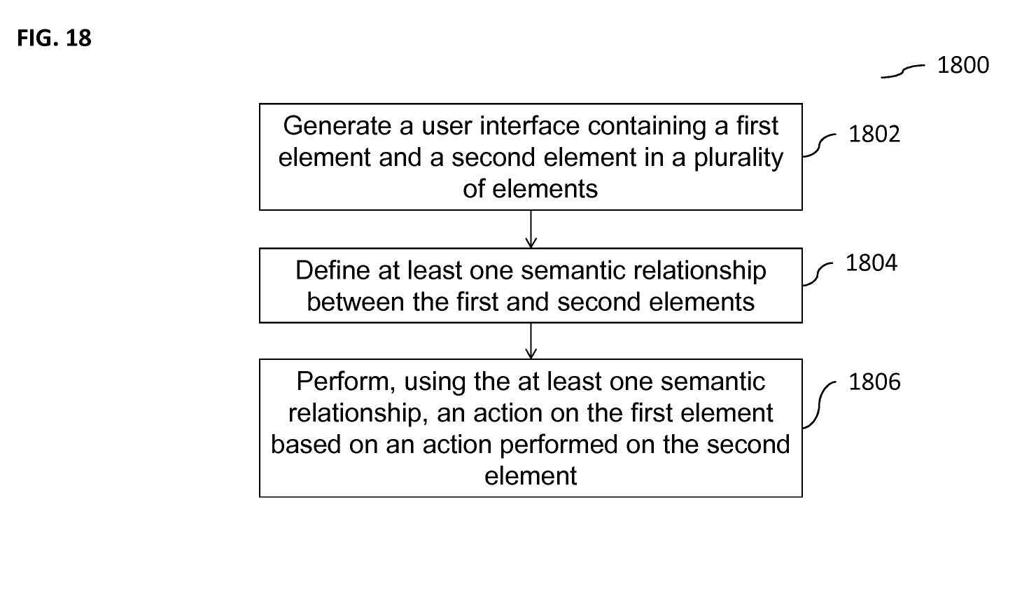

FIG. 18 illustrates an exemplary method 1800, according to some implementations of the current subject matter. At 1802, a user interface containing a first element and a second element in a plurality of elements can be generated. The elements can be any of the elements discussed above with regard to FIGS. 2-13. At 1804, at least one semantic relationship between the first element and the second element can be defined. At 1806, an action on the first element can be performed based on an action performed on the second element in accordance with the semantic relationship between the first and second elements.

In some implementations, the current subject matter can include one or more of the following optional elements. The semantic relationship can include at least one of the following: a group relationship, a line relationship, an association relationship, a headline relationship, a categorization relationship, and a sprite relationship (as discussed above with regard to FIGS. 2-13). The plurality of elements can include at least one of the following: a text, an image, a video, an audio, a note, a document, and a link, and/or any other elements and/or any combination thereof.

In some implementations, the method can also include triggering performance of an action on another element in the plurality of elements based on the action performed on at least one of the first element and the second element (as shown and discussed in connection with FIG. 13).

In some implementations, the semantic relationship can be determined based on a distance between the first element and the second element on the generated user interface. The semantic relationship can also be determined based on respective locations of the first and second element in at least one section of the generated user interface.

In some implementations, the method can also include storing at least one identifier indicative of the semantic relationship and associating the stored identifier with the first element and the second element.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

The systems and methods disclosed herein can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

As used herein, the term “user” can refer to any entity including a person or a computer.

Although ordinal numbers such as first, second, and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed:

1. A computer-implemented method, comprising:
generating a user interface containing a first element and a second element in a plurality of elements;
defining at least one semantic relationship between the first element and the second element; and
performing, using the at least one semantic relationship, an action on the first element based on an action performed on the second element;
wherein at least one of the generating, the defining, and the performing is performed by at least one processor of at least one computing system.

2. The method according to claim 1, wherein the at least one semantic relationship includes at least one of the following: a group relationship, a line relationship, an association relationship, a headline relationship, a categorization relationship, and a sprite relationship.

3. The method according to claim 1, wherein the plurality of elements include at least one of the following: a text, an image, a video, an audio, a note, a document, and a link.

4. The method according to claim 1, further comprising
triggering performance of an action on another element in the plurality of elements based on the action performed on at least one of the first element and the second element.

5. The method according to claim 1, wherein the at least one semantic relationship is determined based on a distance between the first element and the second element on the generated user interface.

6. The method according to claim 1, wherein the at least one semantic relationship is determined based on respective locations of the first and second element in at least one section of the generated user interface.

7. The method according to claim 1, further comprising
storing at least one identifier indicative of the at least one semantic relationship; and
associating the stored identifier with the first element and the second element.

8. A system comprising:
at least one programmable processor; and
a machine-readable medium storing instructions that, when executed by the at least one programmable processor, cause the at least one programmable processor to perform operations comprising:
generating a user interface containing a first element and a second element in a plurality of elements;
defining at least one semantic relationship between the first element and the second element; and
performing, using the at least one semantic relationship, an action on the first element based on an action performed on the second element.

9. The system according to claim 8, wherein the at least one semantic relationship includes at least one of the following: a group relationship, a line relationship, an association relationship, a headline relationship, a categorization relationship, and a sprite relationship.

10. The system according to claim 8, wherein the plurality of elements include at least one of the following: a text, an image, a video, an audio, a note, a document, and a link.

11. The system according to claim 8, wherein the operations further comprise
triggering performance of an action on another element in the plurality of elements based on the action performed on at least one of the first element and the second element.

12. The system according to claim 8, wherein the at least one semantic relationship is determined based on a distance between the first element and the second element on the generated user interface.

13. The system according to claim 8, wherein the at least one semantic relationship is determined based on respective locations of the first and second element in at least one section of the generated user interface.

14. The system according to claim 8, wherein the operations further comprise
storing at least one identifier indicative of the at least one semantic relationship; and
associating the stored identifier with the first element and the second element.

15. A computer program product comprising a machine-readable medium storing instructions that, when executed by at least one programmable processor, cause the at least one programmable processor to perform operations comprising:
generating a user interface containing a first element and a second element in a plurality of elements;
defining at least one semantic relationship between the first element and the second element; and
performing, using the at least one semantic relationship, an action on the first element based on an action performed on the second element.

16. The computer program product according to claim 15, wherein the at least one semantic relationship includes at least one of the following: a group relationship, a line relationship, an association relationship, a headline relationship, a categorization relationship, and a sprite relationship.

17. The computer program product according to claim 15, wherein the plurality of elements include at least one of the following: a text, an image, a video, an audio, a note, a document, and a link.

18. The computer program product according to claim 15, wherein the operations further comprise
triggering performance of an action on another element in the plurality of elements based on the action performed on at least one of the first element and the second element.

19. The computer program product according to claim 15, wherein the at least one semantic relationship is determined based on a distance between the first element and the second element on the generated user interface.

20. The computer program product according to claim 15, wherein the at least one semantic relationship is determined based on respective locations of the first and second element in at least one section of the generated user interface.
